(19) United States
(12) Patent Application Publication
(10) Pub. No.: US 2011/0091663 A1
(43) Pub. Date: Apr. 21, 2011

(54) SUBSTRATE FOR SPORTS AND RECREATION FIELDS, A BACKING FOR AN ARTIFICIAL LAWN PROVIDED WITH SUCH A SUBSTRATE AND A COMPOSITION FOR SUCH A SUBSTRATE

(75) Inventors: Marinus Hendrikus OLDE WEGHUIS, Oldenzaal (NL); Frederik Jan VAN DER GAAG, Nijverdal (NL)

(73) Assignee: TEN CATE SYSTEMS B.V., Nijverdal (NL)

(21) Appl. No.: 12/887,579

(22) Filed: Sep. 22, 2010

(30) Foreign Application Priority Data
Sep. 24, 2009 (NL) 1037326

(51) Int. Cl. A41G 1/00; C08J 5/20

(52) U.S. Cl. 428/17; 521/28

(57) ABSTRACT

The invention relates to a substrate for sports and recreation fields, in particular artificial grass sports fields that contain granular infill material, which substrate comprises at least one component that can leach out upon contact with water and which further comprises a binder material for binding the leached-out component.

The invention also relates to a backing and to an artificial lawn provided with such a substrate.

The object of the invention is to provide an improved substrate for a sports/recreation field as described in the introduction, and in order to accomplish that object the binder material is provided on or in the substrate. This makes it possible in the case of saturation to simply collect and carry off the substrate with the binder material and the leached-out component that is bound thereto or held therein.

The invention relates to a substrate for sports and recreation fields, in particular artificial grass sports fields that contain granular infill material, which substrate comprises at least one component that can leach out upon contact with water and which further comprises a binder material for binding the leached-out component.

The invention also relates to a backing and to an artificial lawn provided with such a substrate.

Granular infill material is used in artificial grass fields to simulate a natural earth surface and to optimise the functional characteristics of the field.

Granular infill material is also used in bound form (for example with a polyurethane adhesive) as a base for athletics tracks. Sand and/or rubbery materials (SBR, EPDM, TPE) are used as granular infill materials. Depending on the type of field and the sport for which the field is intended, the field is infilled with a specific type of granular infill material.

SBR is made from ground tyres and may contain other rubber types, such as natural rubber, isoprene rubber, butadiene rubber etc, in addition to SBR (Styrene-Butadiene-Rubber). In the artificial grass industry, however, the designation SBR is used as a generic name to indicate all granular infill material made from ground tyres, both passenger car tyres and commercial car tyres.

A drawback of SBR used as a granular infill material is that it contains polyaromatic hydrocarbons (PAHs) and heavy metals, which leach out upon contact with water (for example rainwater) and thus find their way into the ground surface that supports the artificial lawn. Zinc (Zn), for example, is such a heavy metal. Zinc is used as a vulcanisation accelerator in the manufacture of tyres. Research has shown that when zinc finds its way into the environment due to leaching, it constitutes a major burden on the environment. PAHs are known to constitute a health hazard. This appears from the research report “Milieu-en gezondheidsaspecten van instrooirubber” (environmental and health aspects of infill rubber) drawn up by the research institute INTRON and published in February 2007.

EPDM and TPE are environmentally friendly alternatives to SBR, for the time being they are more expensive per unit, however.

To prevent pollution of the ground surface that supports the artificial lawn, European patent publication no. 1978156 discloses an artificial lawn provided with a substrate as described in the introduction. In said patent publication, use is made of a binder for binding the leached-out component.

In said patent publication, the binder material is provided as a separate layer between the infilled granular material, or it forms part, in the form of a separate layer, of the ground surface that supports the artificial lawn. Such constructions have the drawback that the binder material is difficult to replace, for example when the binding activity of the binder material has decreased or when the binder material is saturated with the leached-out component. The applications shown in EP1978156 require labour-intensive activities involving the digging out and carrying off of a complete field structure with an excess of contaminated substrate material.

The object of the invention is to provide an improved substrate for a sports/recreation field as described in the introduction, and in order to accomplish that object the binder material is provided on or in the substrate. Since the binder material forms part of the substrate rather than forming a separate part of or being separately provided in the structure—as is the case in the prior art—it is possible in the case of saturation to simply collect and carry off the substrate with the binder material and the leached-out component that is bound thereto or held therein.

More in particular, the binder material is incorporated in a material bonded to the substrate, the bonding material being a coating, more in particular a latex.

In a functional embodiment, the bonding material is provided in a layer on the substrate, so that eventually the binder material will also contain the leached-out component bound to the binder material, encapsulated between the substrate and the bonding material.

In another embodiment, the bonding material is provided in a layer directly underneath the substrate.

In another embodiment, the binder material is according to the invention provided between the substrate and a cover layer attached to the substrate, which cover layer may furthermore be provided on or directly underneath the substrate.

It has been found that the use of a cation exchanger, in particular zeolite, as a binder material is a very functional application, since it has been found by experiment that zinc (Zn) can be bound therewith. In case zeolite is used in, on or underneath the substrate (for example in an artificial lawn), a minimum amount of zeolite of 50-90 g/m² is to be used, depending on the type of zeolite that is used for this purpose. Alternative cation exchangers include resins, for example Dowed® and Amberlite®.

The invention will now be explained in more detail with reference to a drawing, in which:

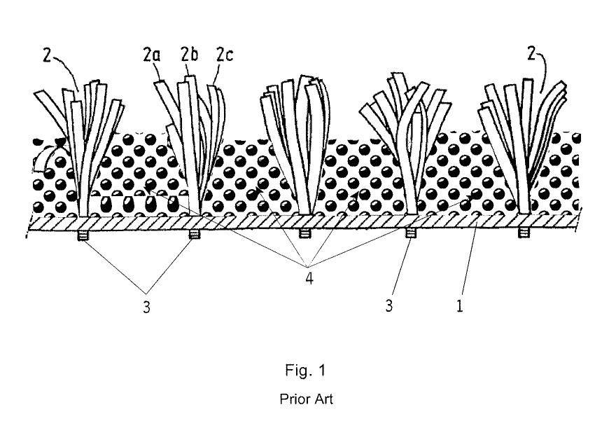

FIG. 1 schematically shows an embodiment of an artificial lawn according to the prior art;

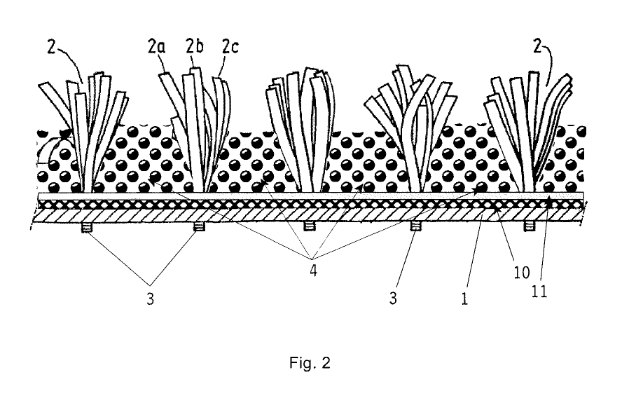

FIGS. 2-4 show different embodiments of an artificial lawn comprising a substrate according to the invention;

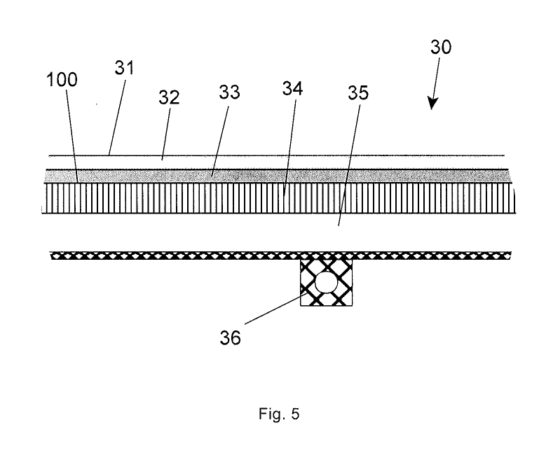

FIG. 5 shows an embodiment of an athletic track comprising a substrate according to the invention;

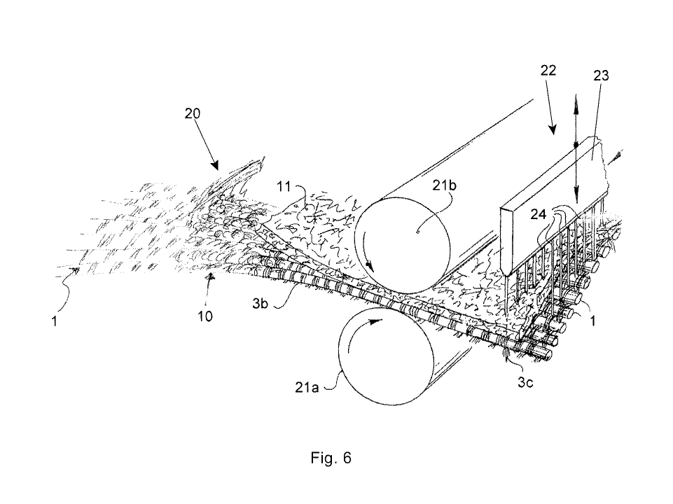

FIG. 6 shows a variant illustrating the method for manufacturing a substrate or a backing for use in an artificial lawn according to the invention.

For a better understanding of the invention, like parts shown in the various figures will be indicated by identical numerals in the description of the figures below.

FIG. 1 shows an embodiment of an artificial lawn in which a granular infill material is used. In the figure, the artificial lawn comprises a backing 1, to which several synthetic fibres 2 are attached, for example by tufting or weaving, at locations indicated at 3. The synthetic fibre 2 may have a random composition and be made of a randomly selected plastic or a mixture of plastic. The synthetic fibre may be attached to the backing as a separate fibre or as a bundle of, for example twined-together, fibres 2a-2c. The synthetic fibre that is used may be a fibrillated band fibre.

Present between the synthetic fibres 2 is a granular infill material 4, which infill material 4 is shown on a much enlarged scale, in the form of spheres, solely for illustrative purposes. Such an artificial grass sports field provided with a granular infill material 4 is known per se and is used in various different embodiments.

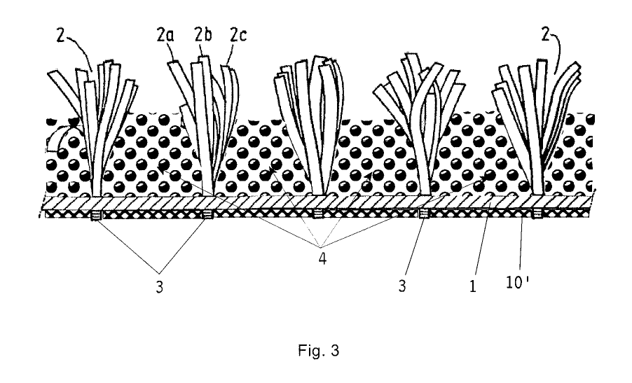

FIGS. 2-4 shows different embodiments of the artificial lawn according to the invention, which is provided with a binder material 10 which is suitable for binding components that can leach from the granular material. The binder material is indicated at 10-10′-10″ in the figures, and is provided on the backing 1 (see FIG. 1) or under the backing 1 (see FIG. 3).

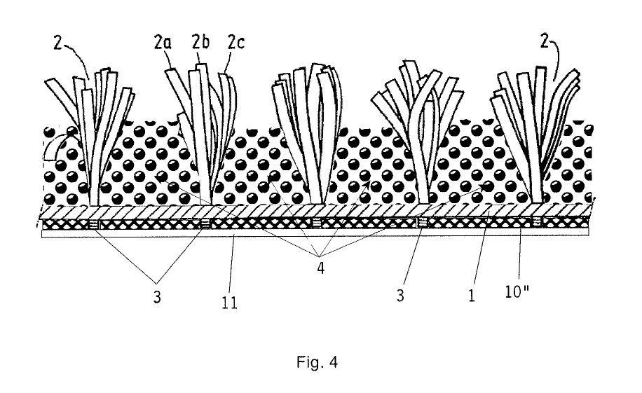

Providing the binder material 10-10′ (and 10″ in FIG. 4) on or in the backing 1 (a substrate) makes it possible to simply collect, remove and carry off the substrate with the binder material 10-10′-10″ for suitable processing when the artificial lawn is to be replaced or removed. In this way the binder material, including the leached-out chemical components bound thereto, is prevented from finding its way into the ground surface yet and thus constituting an environmental burden on the soil.

In the embodiment shown in FIG. 4, the binder material 10″ is provided between the backing 1 and a cover layer 11. The cover layer shown in FIG. 4 may be a geomembrane, with the binder material 10″ being provided between the backing 1 and the cover layer 11 in the form of loose particles.

A similar application is shown in FIG. 2, in which numeral 11 indicates a substrate such as a fabric or a nonwoven layer, between which the binder material is provided. In FIG. 3 the binder material 10′ is provided underneath the backing 1 by means of a coating which compacts the binder material and holds it together. In a specific embodiment, the coating may be used in the form of a latex material, in which the binder material is incorporated. Said coating composed of latex material furthermore serves to bond the synthetic fibres and the backing together, this in order to prevent the fibres from becoming detached as a result of the artificial grass field being played on.

The binder material may preferably be a zeolite which is provided in or on the backing 1 in a distribution rate of at least 50-90 g/m². With this distribution rate of the zeolite it is possible to realise an effecting binding of the leachable components from the granular infill material, for example heavy metals and in particular zinc (Zn). Zeolite NaA as a powder, in the form of a grain (in a mixture with clay), or a zeolite NaA as a mixture based on latex with zeolite have in practice bend found to be useful applications. When, for example, 1.5 kg of dried latex per m² of carpet and a minimum amount of zeolite NaA of 90 g/m² is used, 6% zeolite in dry form (powder) must be added to the latex.

In other applications, zeolite may be provided in or on the backing in granular form. In order to realise a good processability of the zeolite, the zeolite must be bound with a clay which is formed into granules, which granules are baked.

In another application, the zeolite may be extruded into the fibres of which the substrate or the backing is made. In this way a substrate or backing is realised in which the binder material (such as zeolite) is incorporated in the fibre material. The binder material can be readily incorporated into the fibre material during the extrusion process of the fibres (from which the substrate is subsequently formed).

To bind the PAHs that leach from the granular infill material, active carbon, for example, can be used as a binder material, which active carbon can be incorporated in the substrate in a similar manner as described herein.

Also combinations of binder materials, which bind the heavy metals on the one hand and the PAHs on the other hand after they have leached from the granular infill material.

FIG. 5 shows an embodiment of an athletics track which comprises a substrate 100 according to the invention. The athletics track 30 is built up of several sport-specific layers and also comprises a drainage pipe 36 installed in a sandbed, several layers of cellular concrete 34-35 of varying thickness, one or two layers of very porous asphalt 32-33 and on top of that a layer of plastic material 31. Said layer of plastic material may consist of a combination of at least SBR with, for example, a PU adhesive.

According to the invention, the athletics track 30 may comprise a substrate layer 100 provided with a binder material for binding the component (for example a heavy metal) that has leached from the layer of plastic 31. The substrate layer 100 may be provided between the layer of plastic 31 and the asphaltic layer 32.

FIG. 6 shows a method for manufacturing a backing for an artificial lawn, which backing is provided with a binder material according to the invention. Upon manufacture of said multilayer backing, a first layer 1 is supplied by means of conveyor rollers 21a-21b, whereupon the binder material, for example zeolite 10, is applied to the backing in powder form or in granular form at a rate of distribution of at least 50-90 g/m².

Subsequently a cover layer 11 is laid over the binder material, whereupon the backing 1 and the cover layer 11 are attached together by means of a stitching device 22, using needles 24 provided on an arm 23 that can be moved forward and backward. The cover layer 11 and the backing 1 are needled together, using said needles 24, in order to thus confine the binder material 10. Said two layers could also be attached together by means of a chain knitting or other technique.

Below a few examples are given which demonstrate the effectiveness of the binder material in various compositions.

### EXAMPLE 1

10 g of Amberlite® HP 1110 was stirred into a solution of 2.0 g of zinc chloride (ZnCl₂) in 750 ml of demineralized water. The whole was stirred for about 6 hours. Following that, the ion exchanger material was separated from the solution and briefly washed with demineralized water. The solid matter was then dried at 90° C. so as to remove adhering water. Upon subsequent chemical analysis the ion exchanger was found to contain a concentration of 72 mg of zinc (as Zn) per gramme.

### EXAMPLE 2

The above test was repeated, using 10 g of zeolite NaA powder. Upon analysis, a zinc content of 29 mg Zn/gr was measured.

### EXAMPLE 3

10 g of zeolite NaA powder was mixed with 200 g of latex wall paint base (Sigma Coatings). Said mixture was poured into a flat dish and dried overnight at 90° C. The product was a strong, somewhat foamy skin of 163 g, which thus contained (100/163) 61% zeolite. Said skin was ground to a particle size of at most 2 mm, and 10 g of said mixture was tested, using the method of Example 1. Upon analysis, a zinc content of 28 mg Zn/gr was measured.

### EXAMPLE 4

35 g of PE granulate (Dowlex 2108) was processed on a laboratory roller at a temperature of 150° C. to obtain a skin of molten plastic. 35 g of zeolite NaA powder was added thereto under continuous rolling and turning over. Said rolling was continued until a visually homogeneous mixture of zeolite and PE was obtained. 10 g of said mixture was tested, using the method of Example 1. Upon analysis, a zinc content of 29 mg Zn/gr was measured.

We claim:

1. A substrate for sports and recreation fields, in particular artificial grass sports fields that contain granular infill material, which substrate comprises at least one component that can leach out upon contact with water and which further comprises a binder material for binding the leached-out component, characterised in that said binder material is provided on, under or in the substrate.

2. A substrate according to claim 1, characterised in that the binder material is incorporated in a material bonded to the substrate.

3. A substrate according to claim 2, characterised in that the bonding material is a latex.

4. A substrate according to claim 2, characterised in that the bonding material is a coating.

5. A substrate according to claim 2, characterised in that the bonding material is provided in a layer on the substrate.

6. A substrate according to claim 2, characterised in that the bonding material is provided in a layer directly underneath the substrate.

7. A substrate according to claim 1, characterised in that the binder material is provided between the substrate and a cover layer attached to the substrate.

8. A substrate according to claim 7, characterised in that said cover layer is provided on the substrate.

9. A substrate according to claim 7, characterised in that said cover layer is provided directly underneath the substrate.

10. A substrate according to claim 1, characterised in that said binder material is at least zeolite.

11. A substrate according to claim 1, characterised in that said binder material is at least an ion exchanger resin.

12. A substrate according to claim 1, characterised in that said binder material contains at least an active carbon.

13. A substrate according to claim 1, characterised in that the substrate is a backing for an artificial lawn.

14. A backing for an artificial lawn, wherein said backing is provided with a substrate according to claim 1.

15. An artificial lawn, in particular an artificial grass sports field comprising a backing to which artificial grass fibres are attached, as well as a granular infill material provided between said artificial grass fibres, which granular infill material contains at least one component that can leach out upon contact with water, and wherein said backing is provided with a substrate according to claim 1.

16. An artificial lawn, in particular an artificial grass sports field comprising a backing to which artificial grass fibres are attached, as well as a granular infill material provided between said artificial grass fibres, which granular infill material contains at least one component that can leach out upon contact with water, and wherein a substrate according to claim 1 constitutes said backing.

17. A composition consisting of a latex component and a binder material for binding a component that can leach from a granular infill material, being intended for use in a substrate according to claim 1.

18. A composition consisting of a latex component and a binder material for binding a component that can leach from a granular infill material, being intended for use in a backing according to claim 14.

19. A composition consisting of a latex component and a binder material for binding a component that can leach from a granular infill material, being intended for use in an artificial lawn according to claim 15.

20. A composition consisting of a latex component and a binder material for binding a component that can leach from a granular infill material, being intended for use in an artificial lawn according to claim 16.
